(19) United States
(12) Patent Application Publication
(10) Pub. No.: US 2007/0217523 A1
(43) Pub. Date: Sep. 20, 2007

(54) Small Loop Antenna for Induction Reader/Writer

(75) Inventor: Alexander Johannes Jozef Bos, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,005

(22) PCT Filed: Jan. 14, 2005
(86) PCT No.: PCT/IB05/00413

§ 371 Date: Sep. 18, 2006

(30) Foreign Application Priority Data
Mar. 23, 2004 (EP) 04101186.7

(51) Int. Cl. H04L 27/00

(52) U.S. Cl. 375/259; 375/295; 375/316

(57) ABSTRACT

Multiscale communication, wherein time-frequency conditioning off the transmitted signal is used, is examined with respect to typical wireless communications systems, in which the modulating wavelet is matched to a specific channel condition. Compactly supported wavelet bases are employed, and based on their parameterization a wavelet is selected that best characterizes the wireless channel conditions.

### FIELD OF THE INVENTION

The field of the invention is that of wireless communications, in particular that of wavepacket systems that employ separation in both the time and frequency domains.

### BACKGROUND OF THE INVENTION

Wireless communications involves several forms of signal modulation prior to transmission through a mobile channel. Some examples of the type of processing involved in wireless modulation include temporal processing (e.g. spread spectrum), spectral processing (e.g. orthogonal frequency division multiplexing, i.e. OFDM) and spatial processing (e.g. space-time coding). This kind of processing occurs over a single dimension (e.g. time, frequency, or spatial), and is sometimes referred to as single-scale modulation. Usually the type of processing involved is oftentimes selected based on the type of mobile channel conditions experienced. For instance, a mobile channel that provides no diversity (e.g. single-path fading) is sometimes addressed using spatial processing. On the other hand, a mobile channel where multipath is experienced (e.g. frequency-selective fading) may be better handled using spectral modulation such as OFDM.

Multiscale modulation involves processing the signal over two dimensions, namely time and frequency. Therefore, the output of a multiscale modulator is indexed by both a temporal range and frequency bin. This type of signal conditioning has the potential to match to two dimensions of the wireless channel rather than one.

Multiscale modulation can be visualized using a time-frequency tiling diagram. A sample tiling, derived from reference (1) below, is depicted in FIG. 1. The time-frequency tiling of a waveform composed of a sinusoid at frequency f₀ and impulse t₀ in this example results in energy in all subbands in the time-frequency domain intersecting both f₀ and t₀. A time-frequency representation of a signal can be obtained using a wavelet decomposition.

Previous work has addressed the use of the wavelet decomposition in digital communications. For instance, Wornell (8) has developed the concept of fractal modulation for multiscale communication. Moreover, in works such as (9) and (10), an optimal wavelet decomposition is chosen to account for specific types of channel conditions or transmitter imperfections. A particular problem with much previous work in the area of multiscale communications is that the issue of equalization of multipath channels at the receiver is oftentimes not specifically addressed. This is most likely due to the difficulty in trying to adaptively equalize the channel in two dimensions. Thus it would be desirable to be able to match a particular wavelet to instantaneous channel conditions with a minimal amount of interaction (i.e. feedback) between the receiver and transmitter. However, previous work has not addressed taking advantage of compact realizations of large wavelet families so as to match a wavelet with wireless channel conditions based on the selection of one or more scalar values. In this work, based on well-known compact wavelet decompositions, a parameterized wavelet modulation method is developed in which parameters are chosen to best match the wireless channel conditions.

Wavelet decompositions are normally defined in the continuous domain, where the so-called scaling function φ(x) is first derived from references (2), (3) below,
φ(x)=Σcₖφ(2x−k) (1)

where {cₖ} is a real sequence. The sequence {cₖ} is of even length and must satisfy the following:
Σcₖ=2 (2)
Σcₖcₖ₊₂ₘ=2δ(m)

Another important characteristic of wavelets which determines the “smoothness”, or continuity of the sequence defined by {cₖ} is the number of vanishing moments. If the wavelet has M (M≧1) vanishing moments, then the following holds:
Σ(−1)^{k}k^{m}cₖ=0, m=0,1,(M−1) (3)

A corresponding wavelet can now be defined as
ψ(x)=Σdₖψ(2x−k) (4)
where
dₖ=(−1)^{k}c₁₋ₖ (5)

Thus the dilates and translations of the wavelet function form an orthonormal basis:
{\sqrt{2^{j}}ψ(2^{j}x−k)} (6)

Since the wavelet has compact support, the sequence {cₖ} is of finite length, assume that the sequence length is 2N. Then the discrete wavelet transform may be defined starting with the two equal length sequences {cₖ} and {dₖ}. These two sequences can also be thought of as filters; they collectively form a perfect reconstruction filter bank.

A parameterized construction for wavelet and scaling filters for arbitrary values of N with M≦N vanishing moments was proposed in references (3) and (4) below. Let us assume that for a value of N, the filter coefficients are now denoted as {cₖ^{N}}. Given an N-length wavelet parameter set {αᵢ} (−π≦αᵢ<π, 0≦i<N), the coefficients {cₖ^{N}} are derived by the recursion

$${c}_{0}^{0} = \frac{1}{\sqrt{2}} \\ {c}_{1}^{0} = \frac{1}{\sqrt{2}} \\ {c}_{k}^{n} = \frac{1}{2} [ \begin{matrix}( {c}_{k - 2}^{n - 1} + {c}_{k}^{n - 1} ) ( 1 + cos {α}_{n - 1} ) + \\ ( {c}_{2 ( n + 1 ) - k - 1}^{n - 1} + {c}_{2 ( n + 1 ) - k - 3}^{n - 1} ) {( - 1 )}^{k} {α}_{n - 1}\end{matrix} ] \qquad ( 7 )$$

The wavelet construct in reference (7) is restrictive in the sense that the parameter set cannot in general be defined on the [−π,π]^{N} continuum and still yield a wavelet with at least one vanishing moment. Pollen proved however that wavelets can be defined on the continuum [−π,π]^{N} for arbitrary N (at the cost of smoothness). To examine these types of constructs for a given N, let us define the filter bank matrix F_{N} as

$${F}_{N} = [ \begin{matrix}{c}_{0} & … & {c}_{2 N - 1} \\ {d}_{0} & … & {d}_{2 N - 1}\end{matrix} ] \qquad ( 8 )$$

Then the filter bank matrix for N=1 is

$${F}_{1} = \frac{1}{\sqrt{2}} [ \begin{matrix}cos {α}_{0} & - sin {α}_{0} \\ sin {α}_{0} & cos {α}_{0}\end{matrix} ] \qquad ( 9 )$$

The matrix in reference (9) is also sometimes known as the Givens rotation matrix. Similarly, the filter bank matrix for N=2 is 6)

$${F}_{2} = \frac{1}{\sqrt{8}} [ \begin{matrix}1 - cos {α}_{0} + sin {α}_{0} & 1 + cos {α}_{0} + sin {α}_{0} & 1 + cos {α}_{0} - sin {α}_{0} & 1 - cos {α}_{0} - sin {α}_{0} \\ 1 - cos {α}_{0} - sin {α}_{0} & - ( 1 + cos {α}_{0} - sin {α}_{0} ) & 1 + cos {α}_{0} + sin {α}_{0} & - ( 1 - cos {α}_{0} + sin {α}_{0} )\end{matrix} ] \qquad ( 10 )$$

The filter bank expressions for N=2 and N=3 are also sometimes known as Pollen filters, due to the fact that Pollen first proposed these two representations [see reference (7)]. Similarly, the filter bank matrix F₁ becomes the Haar matrix when α₀=π/4 and F₂ is the Daubechies 4-tap filter bank when α₀=π/6. Although the filter selectivity improves with increasing N, this comes at the cost of having to determine a larger set of parameters to define the wavelet. This can be seen in the parameterized expression for {cₖ³}:

$${c}_{0}^{3} = \frac{1}{4} [ ( 1 + cos {α}_{0} + sin {α}_{0} ) ( 1 - cos {α}_{1} - sin {α}_{0} ) + 2 cos {α}_{0} sin {α}_{1} ] \\ {c}_{1}^{3} = \frac{1}{4} [ ( 1 - cos {α}_{0} + sin {α}_{0} ) ( 1 + cos {α}_{1} - sin {α}_{1} ) - 2 cos {α}_{0} sin {α}_{1} ] \\ {c}_{2}^{3} = \frac{1}{2} [ 1 + cos ( {α}_{0} - {α}_{1} ) + sin ( {α}_{0} - {α}_{1} ) ] \\ {c}_{3}^{3} = \frac{1}{2} [ 1 + cos ( {α}_{0} - {α}_{1} ) - sin ( {α}_{0} - {α}_{1} ) ] \\ {c}_{4}^{3} = 1 - {c}_{2}^{3} - {c}_{0}^{3} \\ {c}_{5}^{3} = 1 - {c}_{3}^{3} - {c}_{1}^{3} \qquad ( 11 )$$

Now two parameters must be determined before specifying the filter bank. In fact, although filter selectivity improves with an increasing number of coefficients, the complexity involved in setting the necessary parameters to form the filter bank also increases.

The wavelet decomposition can now be specified in terms of series of filter banks and resampling stages. Given an input sequence aᵢ(n), then the output sequence may be derived as per the processing depicted in FIG. 2.

In modern technology, the filter process is performed digitally with a computational system such as a general purpose computer or an integrated circuit adapted for digital signal processing.

The number of resampling stages in a wavelet decomposition is sometimes referred to as the number of dilations. This processing can also be represented as a transformation of the input sequence by a unitary matrix. Assume that the input sequence at time index i, aᵢ(n) is of (even) length K (i.e. 0≦n<K) and we want to define a discrete wavelet transformation (DWT) matrix T_{K} of size K by K for a particular filter bank matrix F_{N}. Moreover, assume that there are P dilations desired in the transformation. Then using the cited construction, an iterative method for deriving the transformation matrix may be found. Defining the time scale index as 1 (0≦1≦P), a K-by-K filter bank matrix can be defined for each time scale:

$${C}_{l} = [ \begin{matrix}\begin{matrix}{F}_{N} & & {0}_{2 \times ( K - 2 N + 1 )} \\ {0}_{2 \times 2} & {F}_{N} & {0}_{2 \times ( K - 2 N - 1 )} \\ {0}_{2 \times 4} & {F}_{N} & {0}_{2 \times ( K - 2 N - 3 )} \\ ⋮ & ⋰ & ⋮ \\ {0}_{R \times R} & & {I}_{R}\end{matrix} \} & ( K - R ) rows\end{matrix} ] \\ R = \{ \begin{matrix}0 & l = 0 \\ {\sum }_{i = 1}^{P} \frac{K}{{2}^{i}} & l > 0\end{matrix} \qquad ( 12 )$$

In (12), 0_{m×n} is the zero matrix of m rows by n columns, and I_{R} is the identity matrix of R rows by R columns. For each dilation, a permutation matrix Pᵥ (1≦v≦P) can be defined as well:

$${P}_{v} = [ \begin{matrix}\begin{matrix}1 & 0 & ⋯ & 0 & 0 & 0 & 0 & 0 \\ 0 & 0 & 1 & 0 & ⋯ & 0 & 0 & 0 \\ 0 & 0 & 0 & 0 & 1 & 0 & ⋯ & 0 \\ ⋮ & & ⋮ & & & ⋮ & & ⋮\end{matrix} \} & ( \frac{K - R}{2} ) rows \\ \begin{matrix}0 & 1 & 0 & ⋯ & 0 & 0 & 0 & 0 \\ 0 & 0 & 0 & 1 & 0 & ⋯ & 0 & 0 \\ 0 & 0 & 0 & 0 & 0 & 1 & ⋯ & 0 \\ ⋮ & & ⋮ & & & ⋮ & & ⋮ \\ {0}_{R \times R} & & & & & & {I}_{R} & \end{matrix} \} & ( \frac{K - R}{2} ) rows \\ & \end{matrix} ] \\ R = \{ \begin{matrix}0 & l = 0 \\ {\sum }_{i = 1}^{P} \frac{K}{{2}^{i}} & l > 0\end{matrix} \qquad ( 13 )$$

Thus, for P dilations, the unitary transform matrix T_{K} (P) may be determined as
T_{K}(P)=C_{P}P_{P} . . . C₁P₁C₀ (14)

This matrix may now be used to modulate an input vector aᵢ=[aᵢ(0) . . . aᵢ(K−1)]^{T} (i being the symbol index). Illustratively, the elements of the input signal vector ai are the coefficients on a set of basis functions that represent the data, e.g. speech.

Thus the output sequence of such a modulation can be formed as the result of a matrix-vector multiplication xᵢ=T_{K}^{T}(P)aᵢ. As described above, the single net matrix T_{K}(P) represents P inner products of the wavelet with the data. If we assume that F_{N} results from a compact realization of a wavelet, then we can also assume that T_{K}(P) is a function of the wavelet parameter set {aᵢ}, i.e. xᵢ=T_{K}(P, {aᵢ})aᵢ.

### SUMMARY OF THE INVENTION

The invention relates to a multi-carrier communications system that adaptively selects a set of wavelets that match channel conditions.

A feature of the invention is the use of a compact parameterization that permits the generation of an infinite number of wavelet and scaling filter pairs using a finite set of parameters such as the number of dilations and the filter parameters.

Another feature of the invention is the elimination of an equalizer in the receiver by altering the parameters of the wavelets to compensate in advance for changing channel conditions.

### BRIEF DESCRIPTION OF THE DRAWINGS

FIG. 1 shows time-frequency relationship in a wave packet system.

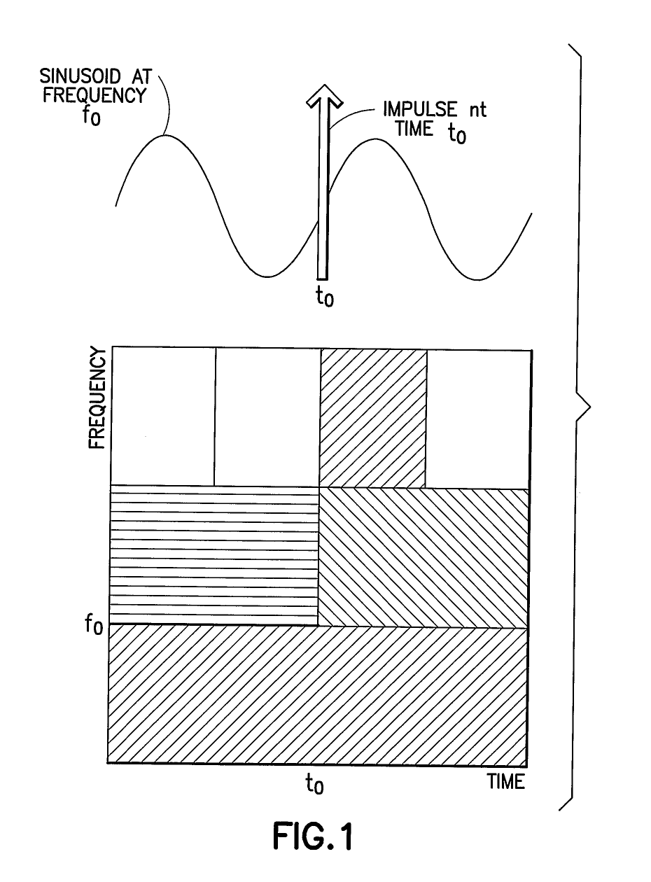

FIG. 2 shows a block diagram of a wavelet transmission system.

FIG. 3 shows quantization noise characteristics

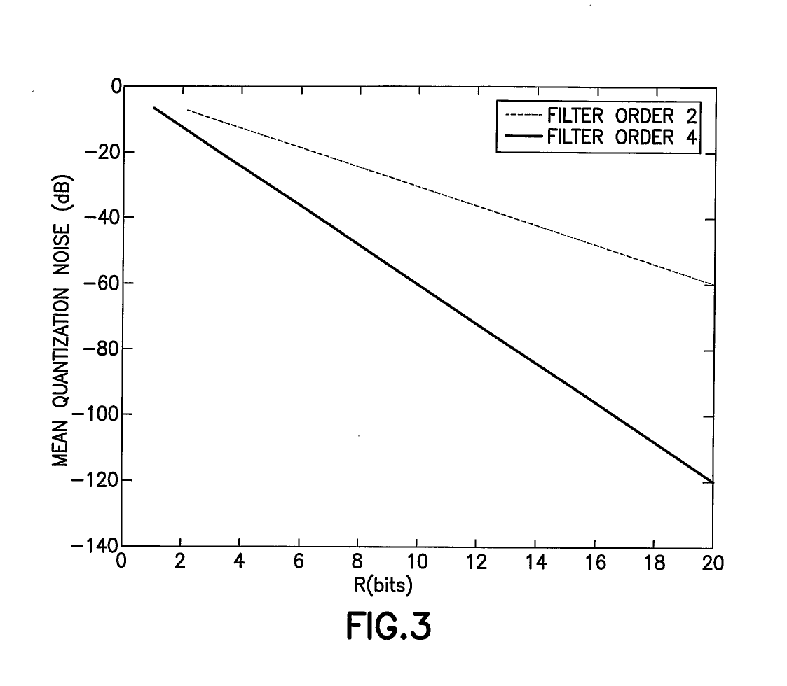

FIG. 4 shows feedback effects in a 2-tap wavelet system.

FIG. 5 shows feedback effects in a 4-tap wavelet system.

FIG. 6 shows dilation effects in a 2-tap wavelet system.

FIG. 7 shows dilation effects in a 4-tap wavelet system.

FIG. 8 compares BER between a wavelet and an OFDM system.

FIG. 9 compares BER in fixed versus adaptive wavelet systems, 2-tap.

FIG. 10 compares BER in fixed verses adaptive wavelet systems, 4-tap.

FIG. 11 shows BER in various systems.

### DETAILED DESCRIPTION

A wavelet-based transmission system can be formed starting with an input vector aᵢ=[aᵢ(0) . . . aᵢ(K−1)]^{T} and forming an output vector xᵢ=T_{K}^{T}(P,{aᵢ})aᵢ in a similar fashion to an OFDM system. However, unlike OFDM systems, which can employ simple equalization structures through the use of cyclic convolution properties of the underlying discrete Fourier transform modulation, a wavelet-based system can be sensitive to frequency-selective wireless channels and therefore the equalization problem for wavelets can become complex.

The output vector xᵢ is transmitted serially. If it is assumed that the wireless channel can be described by an L-tap channel vector hᵢ=[hᵢ(0) . . . hᵢ(L−1)]^{T} (hᵢ is assumed to have unit norm), then the elements of the received signal yᵢ may be represented as (assuming L<K)

$$\begin{matrix}{y}_{i} ( k ) = {\sum }_{m = 0}^{k} {h}_{i} ( m ) {x}_{i} ( k - m ) + {\sum }_{m = k + 1}^{L - 1} {h}_{i} ( m ) {x}_{i - 1} ( K + k - m ) + {n}_{i} ( k ) , \\ 0 \leq k \leq L - 1 \\ = {\sum }_{m = 0}^{L - 1} {h}_{i} ( m ) {x}_{i} ( k - m ) + {n}_{i} ( k ) , L \leq k < K - 1\end{matrix} \qquad ( 15 )$$

In (15), nᵢ(k) is an additive noise term. The typical equalization techniques for this type of received signal are decision-aided, requiring an estimate of the previous transmitted symbol as aᵢ₋₁ to account for intersymbol interference (ISI) and estimates of the individual entries of xᵢ to account for intercarrier interference (ICI). This expression can also be expressed in matrix-vector format:
yᵢ=Hᵢxᵢ+H_{IXI}_{_{—}}ᵢxᵢ₋₁+nᵢ (16)

In equation (16), Hᵢ, H_{ISI}_{_{—}}ᵢ, and nᵢ are described as below:

$${H}_{i} = [ \begin{matrix}{h}_{0} & 0 & ⋯ & 0 & 0 & 0 & 0 & 0 & 0 \\ {h}_{1} & {h}_{0} & 0 & ⋯ & 0 & 0 & 0 & 0 & 0 \\ {h}_{2} & {h}_{1} & {h}_{0} & 0 & ⋯ & 0 & 0 & 0 & 0 \\ ⋮ & & & & ⋮ & & & & ⋮ \\ 0 & ⋯ & 0 & 0 & 0 & {h}_{L - 1} & ⋯ & {h}_{1} & {h}_{0}\end{matrix} ]$$

$${H}_{ISI\_i} = [ \begin{matrix}0 & ⋯ & 0 & {h}_{L - 1} & ⋯ & {h}_{2} & {h}_{1} \\ 0 & 0 & ⋯ & 0 & {h}_{L - 1} & ⋯ & {h}_{2} \\ 0 & 0 & 0 & ⋯ & 0 & ⋰ & ⋮ \\ 0 & 0 & 0 & 0 & ⋯ & 0 & {h}_{L - 1} \\ 0 & 0 & 0 & 0 & 0 & ⋯ & {h}_{L - 1} \\ ⋮ & & & ⋮ & & & ⋮ \\ 0 & 0 & 0 & 0 & 0 & ⋯ & 0\end{matrix} ]$$

$${n}_{i} = {[ \begin{matrix}{n}_{i} ( 0 ) & {n}_{i} ( 1 ) & … & {n}_{i} ( K - T )\end{matrix} ]}^{T}$$

What is proposed instead is to utilize compact parameterization of wavelets to pre-equalize the channel. In other words, if there is an estimate of a set of parameters for a given filter bank matrix F_{N} which maximizes received signal quality, then this information can be used to modify the modulation matrix T_{K}. If it is assumed that there is sufficient training data to form a channel estimate at the receiver ĥᵢ, then the best wavelet parameterization set may be found utilizing additional training data and the K-by-K channel estimation matrix:

$${\hat{H}}_{i} = [ \begin{matrix}{\hat{h}}_{0} & 0 & ⋯ & 0 & 0 & 0 & 0 & 0 & 0 \\ {\hat{h}}_{1} & {\hat{h}}_{0} & 0 & ⋯ & 0 & 0 & 0 & 0 & 0 \\ {\hat{h}}_{2} & {\hat{h}}_{1} & {\hat{h}}_{0} & 0 & ⋯ & 0 & 0 & 0 & 0 \\ ⋮ & & & & ⋮ & & & & ⋮ \\ 0 & ⋯ & 0 & 0 & 0 & {\hat{h}}_{L - 1} & ⋯ & {\hat{h}}_{1} & {\hat{h}}_{0}\end{matrix} ] \qquad ( 17 )$$

Clearly, applying a unitary transformation will not reduce the power of additive Gaussian noise; however, a unitary transformation such as a DWT could be applied to minimize the two sources of interference seen in frequency selective channels by multicarrier systems, namely ICI and ISI. Using this channel estimation matrix, the optimal wavelet parameterization set which minimizes ICI for a given P can be found as

$${min}_{\{ {α}_{r} \} ∈ {ℜ}^{N}} ‖ {T}_{K}^{T} ( P , \{ {α}_{r} \} ) {\hat{H}}_{i} {T}_{K} ( P , \{ {α}_{r} \} ) - {I}_{K} ‖ \qquad ( 18 )$$

Additional criteria could be established to minimize ISI. This would involve selection of a wavelet transform that would render ISI contributions from any given wavelet symbol to the ensuing wavelet symbol negligible. Based on the ISI contributions evident in (15), we define the K-by-K channel matrix:

$${\hat{H}}_{ISI\_i} = [ \begin{matrix}0 & … & 0 & {\hat{h}}_{L - 1} & … & {\hat{h}}_{2} & {\hat{h}}_{1} \\ 0 & 0 & … & 0 & {\hat{h}}_{L - 1} & … & {\hat{h}}_{2} \\ 0 & 0 & 0 & … & 0 & ⋰ & ⋮ \\ 0 & 0 & 0 & 0 & … & 0 & {\hat{h}}_{L - 1} \\ 0 & 0 & 0 & 0 & 0 & … & 0 \\ ⋮ & & & ⋮ & & & ⋮ \\ 0 & 0 & 0 & 0 & 0 & … & 0\end{matrix} ] \qquad ( 19 )$$

Thus, another optimization criterion that minimizes ISI may be considered:
(20)

$${min}_{\{ {α}_{r} \} ∈ {ℜ}^{N}} ‖ {T}_{K}^{T} ( P , \{ {α}_{r} \} ) {\hat{H}}_{ISI\_i} {T}_{K} ( P , \{ {α}_{r} \} ) ‖$$

In addition to selection of a wavelet that minimizes ICI and ISI, the wavelet itself cannot be considered to have approximately equalized the channel unless the energy along the resultant diagonal is maximized. This results directly in maximizing received signal energy. The criterion that maximizes the energy along the diagonal (assuming A is a diagonal operator) is:

$${min}_{\{ {α}_{r} \} ∈ {ℜ}^{N}} \frac{1}{‖ Λ ( {T}_{K}^{T} ( P , \{ {α}_{r} \} ) {\hat{H}}_{i} {T}_{K} ( P , \{ {α}_{r} \} ) ) ‖} \qquad ( 21 )$$

It cannot be assumed that a single parameter set will minimize ISI and ICI while maximizing recovered channel energy. Thus, the wavelet parameter selection should be based on a criterion that minimizes all of the residual interference:

$${min}_{\{ {α}_{r} \} ∈ {ℜ}^{N}} ‖ {T}_{K}^{T} ( P , \{ {α}_{r} \} ) {\hat{H}}_{i} {T}_{K} ( P , \{ {α}_{r} \} ) - {\hat{h}}_{0} {I}_{K} ‖ + ‖ {T}_{K}^{T} ( P , \{ {α}_{r} \} ) {\hat{H}}_{ISI\_i} {T}_{K} ( P , \{ {α}_{r} \} ) ‖ + \frac{1}{‖ Λ ( {T}_{K}^{T} ( P , \{ {α}_{r} \} ) {\hat{H}}_{i} {T}_{K} ( P , \{ {α}_{r} \} ) ) ‖} \qquad ( 22 )$$

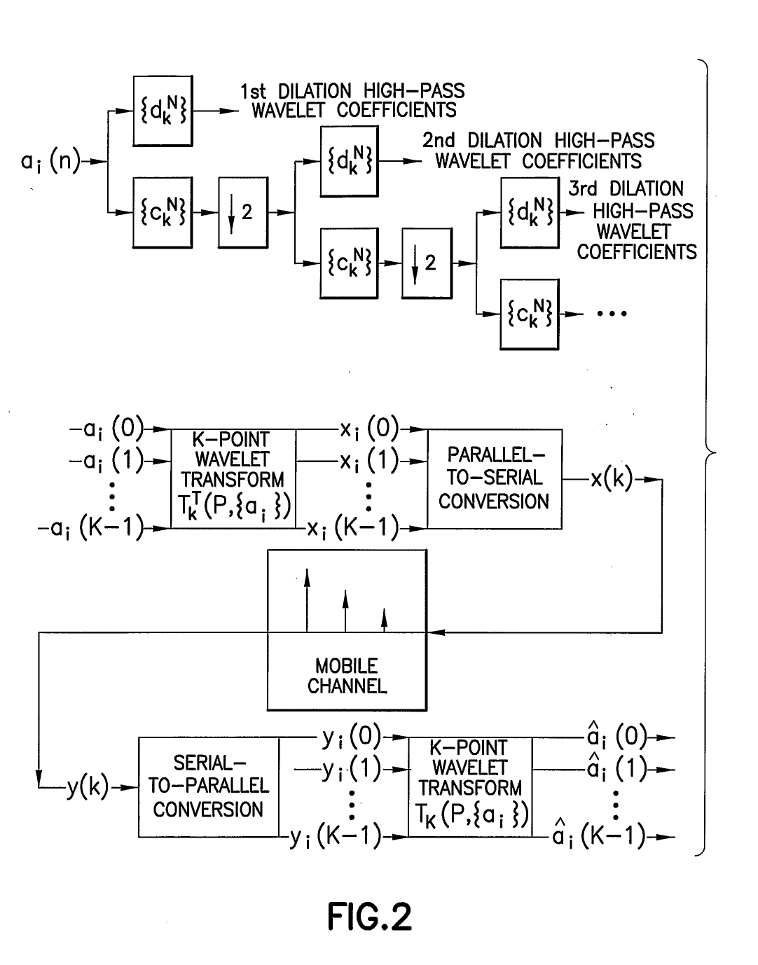

Finally, the wavelet transmission method is as depicted in FIG. 2.

Summarizing, the process according to the invention is:

Starting with an estimated channel matrix, and an initial parameter set alpha that specifies an initial wavelet (assuming P is fixed).

Send training signals from the transmitter (base station) to the receiver.

In the receiver iterate (or otherwise compute) the value of adjusted wavelet parameters that minimize the ICI, the ISI and the total residual interference.

Send the adjusted parameters back along a feedback path to the transmitter.

Use the adjusted parameters in transmission for the next period until the next adjustment.

It should be noted that there could still be residual interference even after wavelet selection. This would result from effects such as feedback latency with respect to the coherence time of the channel, reduced parameter search space, etc. As a result, some limited form of interference cancellation may still be necessary even when the wavelet is best matched to channel conditions. Moreover, using the metric in equation (22) does not maximize diversity seen in the system; it only optimizes ICI and ISI.

The design of parameterized wavelets poses a classic problem in adaptive waveform design for wireless transmission in a system where the receiver must convey information on the channel conditions to the transmitter: how to minimize the throughput required for relaying the necessary information from the receiver to the transmitter for accurate waveform selection. This is normally not a problem in time division duplexed (TDD) systems, as it is generally assumed that a TDD transmitter can estimate channel conditions seen at the TDD receiver without feedback. However, paired-band systems generally do not have sufficient correlation between transmit and receive frequencies used by a given transceiver. Thus minimizing the amount of information to be relayed by the receiver to the transmitter for waveform selection is critical.

However, the wavelet filter bank matrix selectivity clearly improves with increasing order 2N. This requires greater parameterization, thus potentially increasing the required feedback information. Thus given a maximum feedback data payload R (bits), there exists a tradeoff between increasing the filter bank selectivity and reducing the quantization noise of the feedback parameters. If we assume that each value in the parameter set {αᵢ} is uniformly quantized between 0 and π, we can find the mean quantization error as

$${σ}_{η}^{2} = \frac{1}{12} {( \frac{π}{{2}^{⌊ \frac{R}{N} ⌋}} )}^{2} \qquad ( 23 )$$

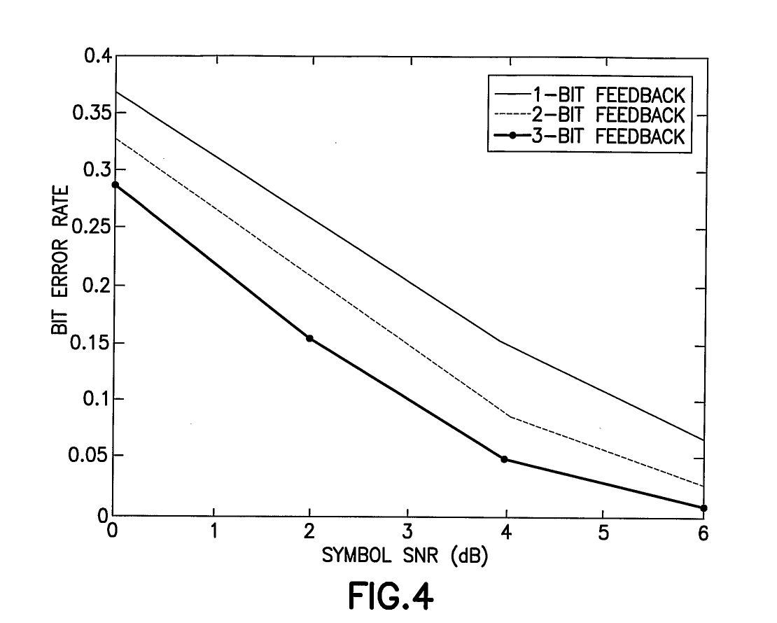

In equation (23), the quantization error is derived from the classic result on uniform quantization of a uniformly distributed random variable. Unfortunately, this error variance in and of itself may not give sufficient insight into the degradation of a wavelet-based communications system due to throughput limitations for feedback of wavelet parameter selection. However, it could provide an indication of the optimal filter bank order given specific feedback limitations. The quantization noise for filter orders of 2 and 4 is depicted in FIG. 4. In the left region of the curve, quantization noise increases to unacceptable levels with increasing filter order. However, in the right region of the curve, quantization noise tends to drop below unacceptable levels with increasing filter order (although quantization noise still worsens with increasing filter order for any given value of R). This is not surprising, as it stands to reason that increasing throughput payloads will allow for more accurate quantization of an increasing number of wavelet parameters, ergo allowing for higher-order filterbanks.

A relevant question is what constitutes an “unacceptable level” of quantization noise, as it would stand to reason that for a given value of R, the filter order that should be selected is the maximum one which falls below this level.

FIG. 2 illustrates the process of forming the coefficients that produce a given wavelet. A set of signal coefficients as representing the speech or other data are input on the left and are processed (e.g. by a general purpose computer system) to generate the final coefficients that define the particular wavelets used in the transmitter.

In operation, in a system according to the invention, the transmitter periodically sends a reference signal (a training sequence) to the receiver. The receiver applies known algorithms to the received signal to estimate the channel matrix. The receiver then transforms the channel matrix using various trial parameters and selects the parameters that give the result that best fits a criterion such as that expressed in Equation 22 that minimizes ICI and ISI.

The “best fit” parameters are relayed to the transmitter along a feedback channel having a limited number of bits

The transmitter then prepares packets using the parameters sent to it by the receiver for the duration of the period.

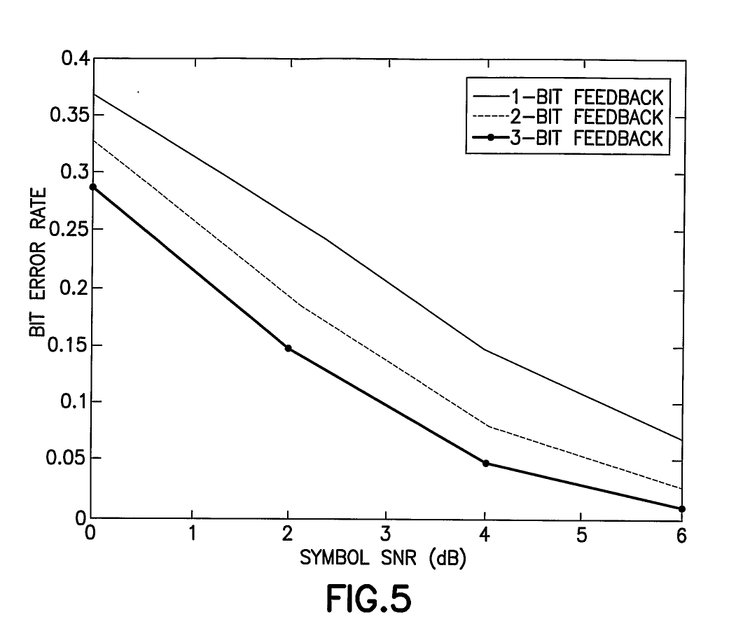

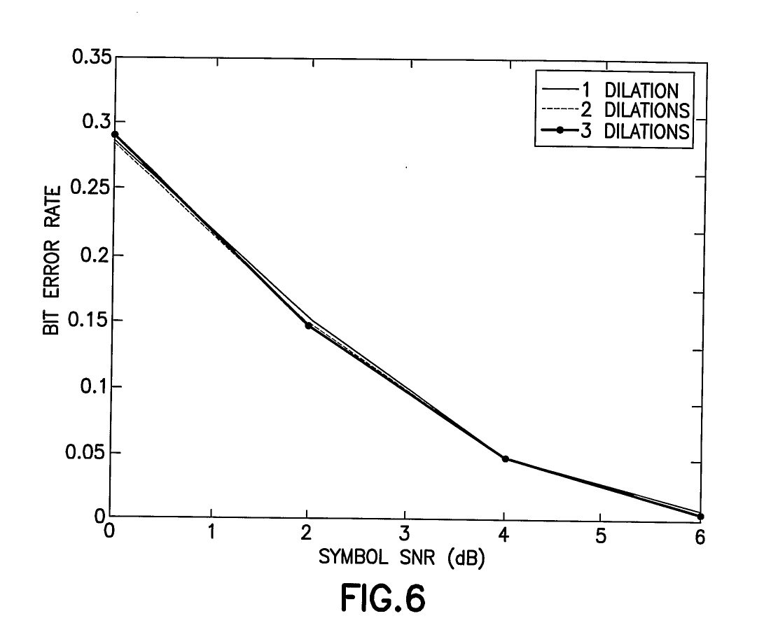

A test over a specific channel profile was conducted for several different types of wavelet decompositions to examine the feasibility of adapting the wavelet to the instantaneous channel conditions based on their parameterization. Assuming an input vector of dimension 32 modulated by a square wavelet transformation matrix, a transmission system was tested at a wavelet symbol rate of 250 kHz (symbol rate in this case refers to the rate at which all 32 wavelet coefficients resulting from a single input vector was transmitted). The two-tap and four-tap wavelet models of (9) and (10) were examined for performance of BPSK signaling in a multipath fading channel (channel tap power profile of [.8 .1 .1]) at an assumed carrier frequency of 5 GHz and velocity of 3 km/hr. In the system modeling, the wavelet parameter was selected every 50 symbols. Under these conditions, the performance of the 2-tap and 4-tap wavelets with respect to feedback quantization is given in FIG. 5 and FIG. 6, respectively.

Under these conditions, the benefits of increasing feedback naturally become less prevalent as the number of bits increases. In this environment, although increasing feedback would yield 6 dB of quantization noise relief, this clearly does not translate to the same benefits in terms of overall performance. It should also be noted that the results are graphed in terms of raw BPSK bit error rate; an additional error correcting code could translate to less benefits for increasing the number of feedback bits. Another thing to notice is that the performance of the 2-tap and 4-tap wavelet systems was roughly the same.

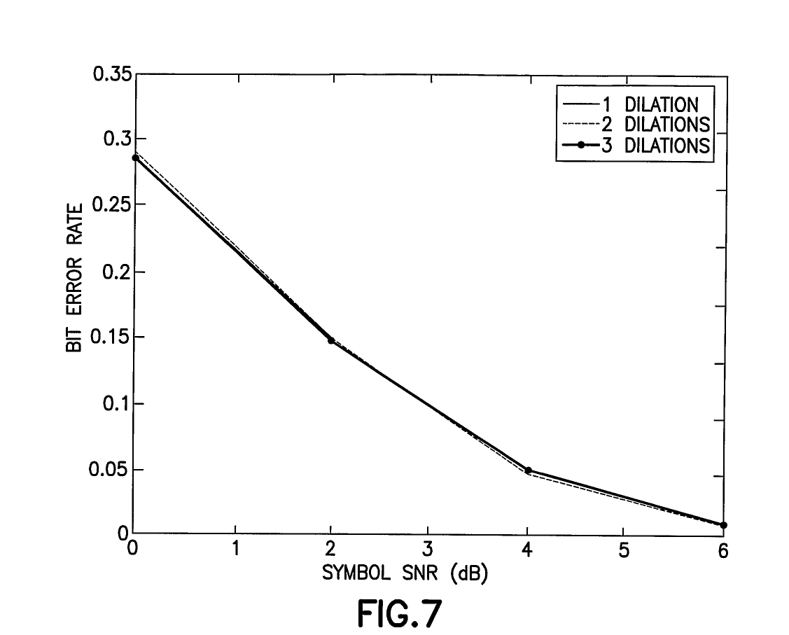

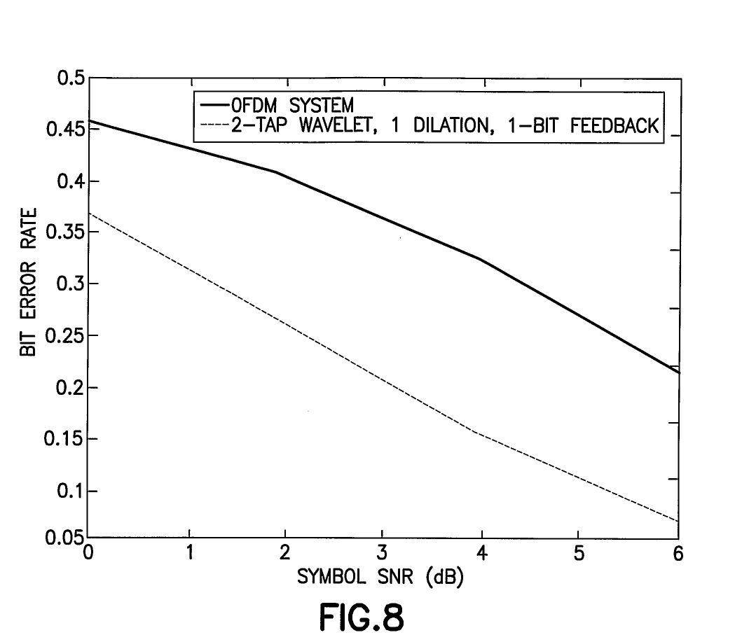

In addition, the number of dilations could possibly impact the performance of the proposed method of wavelet transmission. Once again, the results for both the 2-tap and 4-tap wavelets assuming 3-bit feedback quantization are provided in FIG. 7 and FIG. 8, respectively. Increasing the number of dilations did not provide much benefit in improving performance of the system. This could most likely be because of the fact that the channel conditions under consideration are already fairly compact in frequency and in time; the greatest performance enhancement of this method is to change the fundamental wavelet filterbank rather than changing the time-frequency decomposition of the transmitted signal.

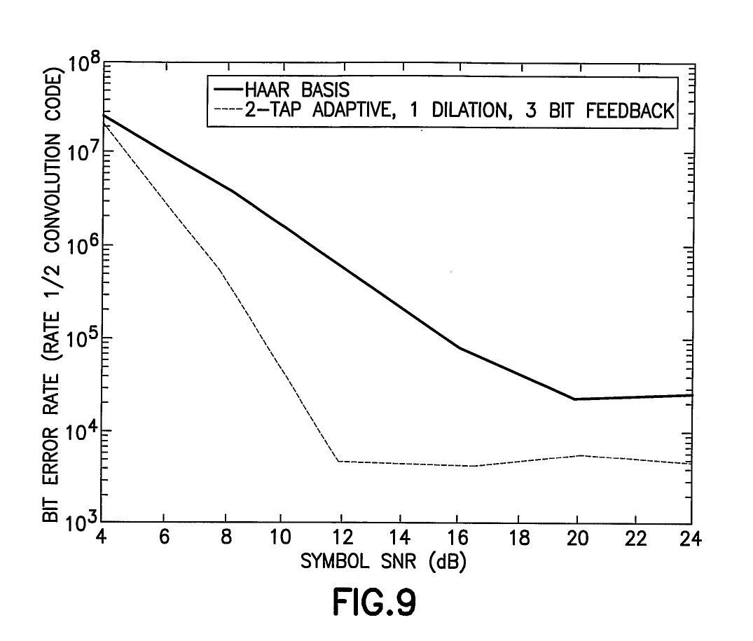

To better appreciate the maximum achievable benefits of multiscale communications, an OFDM system was simulated using identical channel conditions and identical input vector size. A comparison to the 2-tap wavelet with and one bit of feedback is given in FIG. 9. The performance enhancements due to wavelet modulation are seen to be as much as 3 dB. Taking into account that the OFDM system is transmitted in quadrature while the wavelet system does not require quadrature transmission for BPSK signaling, it is clear that the spectral efficiency of the wavelet system is potentially much higher than the OFDM system.

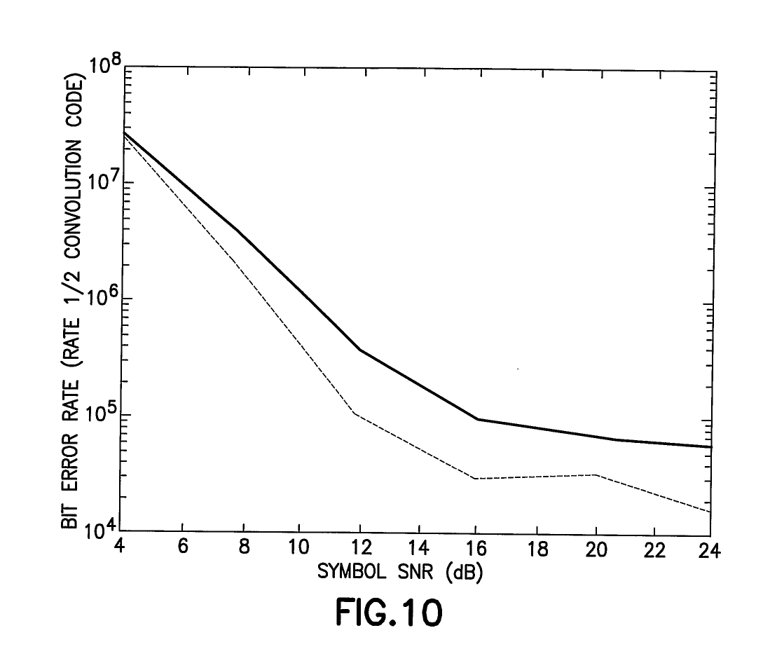

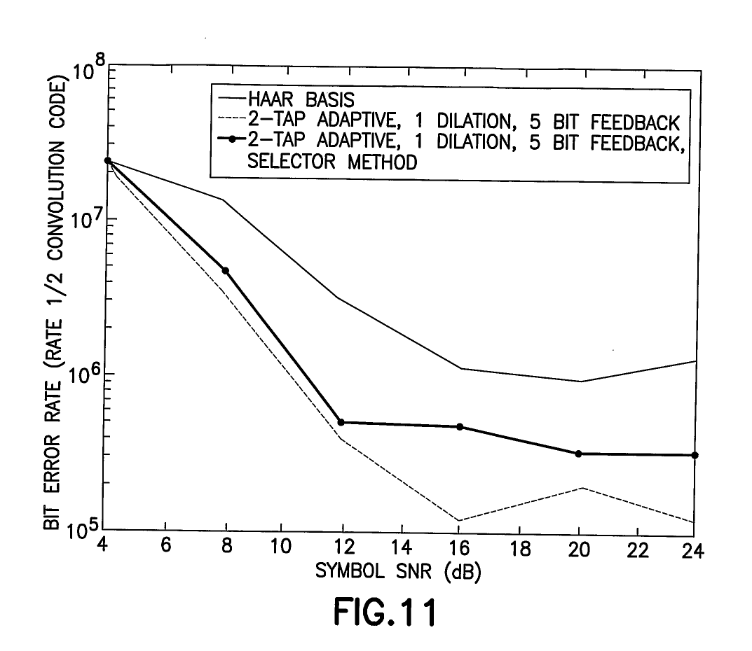

Some more results were obtained for the adaptive method in fading channels and compared to the use of a fixed method (in this case, the Haar basis and Daubechies 4-tap). Using a channel tap profile of [.8 .2] along with a symbol rate of 125 kHz and an input vector size of 64, the fixed and adaptive methods were compared under fading conditions with a carrier frequency of 5 GHz and a velocity of 150 km/hr. A rate ½ convolutional code was used, meaning that an input segment of 32 bits was coded into an input vector of 64 binary symbols (BPSK signaling). The results are shown in FIG. 10 and FIG. 11.

Both of the methods seem to converge at low SNR. This is due to AWGN being the overriding source of error in this operating region; no adaptation can enhance the link under such conditions. In addition, note that both methods do result in an error floor. For the fixed case, this is due to a suboptimal wavelet being used for transmission. In the adaptive case, this is due in part to the use of limited feedback. However, even assuming infinitely precise quantization of the parameterization space, it should still be re-asserted that the selected wavelet will be an approximation of the equalizing transform.

The wavelet selection method given above, particularly the criterion presented in Equation (22), was examined versus the fixed method in the static channel profile of [.5 .3 .1 .1]. In this case, the feedback quantization was increased to 5 bits so as to more accurately examine whether the wavelet selection actually selects the best wavelet. More specifically, under the assumptions of coarse quantization, the likelihood of picking the correct wavelet using the wavelet selection method increases; therefore the accuracy of this method is not so easy to assess under such conditions. The results for the 2-tap method are given in FIG. 12. Note that the wavelet selection method retained the gains of the adaptive method versus the use of a fixed wavelet. Note also that the error floor is still present, although at a bit error rate between 10⁻⁴ and 10⁻³.

Although the invention has been described with respect to a limited number of embodiments, those skilled in the art will appreciate that other embodiments may be constructed within the spirit and scope of the following claims.

(1) Vetterli, Martin and Jelena Kovacevic. Wavelets and Subband Coding. Englewood Cliffs, N.J.: Prentice-Hall Inc., 1995.
(2) Strang, Gilbert and Truong Nguyen. Wavelets and Filter Banks. Wellesley, Mass.: Wellesley-Cambridge Press, 1996.
(3) Zou, Hehong and Ahmed H. Tewfik. “Parameterization of Compactly Supported Orthonormal Wavelets.” IEEE Transactions on Signal Processing. Vol.41. No.3. March 1993. pp. 1428-1431.
(4) Sclumeid, J. and S. Pittner. “On the Parameterization of the Coefficients of Dilation Equations for Compactly Supported Wavelets.” Computing. Vol. 51. May 1993. pp. 165-173.
(5) Vidakovic, Brani. “Pollen Bases and Daubechies-Lagarias Algorithm in MATLAB.” Jacket's Wavelets website. http://www.isye.gatech.edu/˜brani/datasoft/DL.pdf.
(6) Silva, Vitor and Luis de Sa. “Analytical Optimization of CQF Filter Banlks.” IEEE Transactions on Signal Processing. Vol. 44. No. 6. June 1996. pp. 1564-1568.
(7) Pollen, D. “Parameterization of Compactly Supported Wavelets.” Aware Inc. technical report AD890503. May 1989.
(8) Woniell, Gregory W. “Emerging Applications of Multirate Signal Processing and Wavelets in Digital Communications.” Proceedings of the IEEE. Vol. 84. No. 4. April 1996. pp. 586-603.
(9) Lindsey, Alan R. “Wavelet Packet Modulation for Orthogonally Multiplexed Communication.” IEEE Transactions on Signal Processing. Vol. 45. No. 5. May 1997. pp. 1336-1339.
(10) Wong, K.-M., Wu, J., Davidson, T. N. and Jin, Q “Wavelet Packet Division Multiplexing and Wavelet Packet Design under Timing Error Effects.” IEEE Transactions on Signal Processing. Vol. 45. No. 12. December 1997. pp. 2877-2890.

What is claimed is:

1. A telecommunications system comprising:
means for receiving an input vector signal;
controllable variable transformation means for modulating said input signal with a transform having a compact parameter representation with P dilations, and further characterized by a parameter set, said transformations means having a parallel output set of data;
parallel to serial means for converting said parallel set of data to a serial set of data;
transmitting means for transmitting said serial set of data along a channel;
receiving means for receiving said serial set of data;
serial to parallel means for converting received serial data to parallel data; and
inverse transformation means for demodulating said parallel data in accordance with said compact parameter representation.

2. A system according to claim 1, in which said process of modulating is effected by multiplying a vector representing input data with a modulation matrix representing the transform.

3. A system according to claim 1, in which said receiving means contains means for processing test data to extract parameters for specifying said modulation matrix.

4. A system according to claim 3, in which said process of modulating is effected by multiplying a vector representing input data with a modulation matrix representing the transform.

5. A system according to claim 3, in which said means for processing test data to extract parameters seeks parameters that minimize residual interference, including ISI and ISI.

6. A system according to claim 3, in which said means for processing test data to extract parameters seeks parameters that minimize ICI.

7. A system according to claim 3, in which said means for processing test data to extract parameters seeks parameters that minimize ISI.

8. A telecommunications system comprising:
means for receiving an input vector signal;
controllable variable transformation means for modulating said input signal with a transform having a compact parameter representation with P dilations, and further characterized by a parameter set, said transformations means having a parallel output set of data;
parallel to serial means for converting said parallel set of data to a serial set of data;
transmitting means for transmitting said serial set of data along a channel;
receiving means for receiving said serial set of data;
serial to parallel means for converting received serial data to parallel data;
inverse transformation means for demodulating said parallel data in accordance with said compact parameter representation; and
adjustment means for adjusting said parameter set in response to changing channel conditions.

9. A system according to claim 8, in which said process of modulating is effected by multiplying a vector representing input data with a modulation matrix representing the transform.

10. A system according to claim 8, in which said receiving means contains means for processing test data to extract parameters for specifying said modulation matrix.

11. A system according to claim 10, in which said process of modulating is effected by multiplying a vector representing input data with a modulation matrix representing the transform.

12. A system according to claim 10, in which said means for processing test data to extract parameters seeks parameters that minimize residual interference, including ISI and ISI.

13. A system according to claim 10, in which said means for processing test data to extract parameters seeks parameters that minimize ICI.

14. A system according to claim 10, in which said means for processing test data to extract parameters seeks parameters that minimize ISI.

15. A method of operating a telecommunications system comprising the steps of:
receiving an input vector signal;
modulating said input signal in controllable variable transformation means with a transform having a compact parameter representation with P dilations, and further characterized by a parameter set, said transformation means having a parallel output set of data;
converting said parallel set of data to a serial set of data;
transmitting said serial set of data along a channel;
receiving said serial set of data;
converting received serial data to parallel data; and
demodulating said parallel data in accordance with said compact parameter representation.

16. A method according to claim 15, in which said receiving means processes test data to extract parameters for specifying said modulation matrix.

17. A method according to claim 15, in which said process of modulating is effected by multiplying a vector representing input data with a modulation matrix representing the transform.

18. A method according to claim 15, in which said step of processing test data to extract parameters seeks parameters that minimize residual interference, including ISI and ISI.

19. A method according to claim 15, in which said step of processing test data to extract parameters seeks parameters that minimize ICI.

20. A method according to claim 15, in which said step of processing test data to extract parameters seeks parameters that minimize ISI.

21. A method of operating a telecommunications system comprising the steps of:
receiving an input vector signal;
modulating said input signal in controllable variable transformation means with a transform having a compact parameter representation with P dilations, and further characterized by a parameter set, said transformation means having a parallel output set of data;
converting said parallel set of data to a serial set of data;
adjusting said parameter set in response to changing channel conditions;
transmitting said serial set of data along a channel;
receiving said serial set of data;
converting received serial data to parallel data; and
demodulating said parallel data in accordance with said compact parameter representation.

22. A method according to claim 21, in which said receiving means processes test data to extract parameters for specifying said modulation matrix.

23. A method according to claim 21, in which said process of modulating is effected by multiplying a vector representing input data with a modulation matrix representing the transform.

24. A method according to claim 21, in which said step of processing test data to extract parameters seeks parameters that minimize residual interference, including ISI and ISI.

25. A method according to claim 21, in which said step of processing test data to extract parameters seeks parameters that minimize ICI.

26. A method according to claim 21, in which said step of processing test data to extract parameters seeks parameters that minimize ISI.

27. All article of manufacture comprising a program storage medium readable by a computer, the medium embodying instructions executable by the computer for performing method steps of operating a telecommunications system comprising the steps of:
receiving an input vector signal;
modulating said input signal in controllable variable transformation means with a transform having a compact parameter representation with P dilations, and further characterized by a parameter set, said transformation means having a parallel output set of data;
converting said parallel set of data to a serial set of data;
transmitting said serial set of data along a channel;
receiving said serial set of data;
converting received serial data to parallel data; and
demodulating said parallel data in accordance with said compact parameter representation.

28. A method according to claim 15, in which said receiving means processes test data to extract parameters for specifying said modulation matrix.

29. A method according to claim 15, in which said process of modulating is effected by multiplying a vector representing input data with a modulation matrix representing the transform.

30. A method according to claim 15, in which said step of processing test data to extract parameters seeks parameters that minimize residual interference, including ISI and ISI.

31. A method according to claim 15, in which said step of processing test data to extract parameters seeks parameters that minimize ICI.

32. A method according to claim 15, in which said step of processing test data to extract parameters seeks parameters that minimize ISI.

33. An article of manufacture comprising a program storage medium readable by a computer, the medium embodying instructions executable by the computer for performing method steps of operating a telecommunications system comprising the steps of:
receiving an input vector signal;
modulating said input signal in controllable variable transformation means with a transform having a compact parameter representation with P dilations, and further characterized by a parameter set, said transformation means having a parallel output set of data;
converting said parallel set of data to a serial set of data;
adjusting said parameter set in response to changing channel conditions;
transmitting said serial set of data along a channel;
receiving said serial set of data;
converting received serial data to parallel data; and
demodulating said parallel data in accordance with said compact parameter representation.

34. A method according to claim 33, in which said receiving means processes test data to extract parameters for specifying said modulation matrix.

35. A method according to claim 33, in which said process of modulating is effected by multiplying a vector representing input data with a modulation matrix representing the transform.

36. A method according to claim 33, in which said step of processing test data to extract parameters seeks parameters that minimize residual interference, including ISI and ISI.

37. A method according to claim 33, in which said step of processing test data to extract parameters seeks parameters that minimize ICI.

38. A method according to claim 33, in which said step of processing test data to extract parameters seeks parameters that minimize ISI.

39. A transmitter comprising:
an input port for receiving an input vector signal to be transmitted;
a modulator for modulating said input signal with a transform having a compact parameter representation with P dilations, and further characterized by a parameter set, said modulator providing a parallel output set of data;
a parallel to serial converter for converting said parallel set of data to a serial set of data; and
a transmit antenna for transmitting said serial set of data along a channel.

40. A receiver comprising:
a receive antenna for receiving a serial set of data over a channel;
a serial to parallel converter for converting said received serial data to parallel data; and
a demodulator for demodulating said parallel data in accordance with a compact parameter representation having P dilations, said representation further characterized by a parameter set.

41. The receiver of claim 40 further comprising:
a controller for adjusting said parameter set in response to changing conditions of the channel.
